(19) United States
(12) Patent Application Publication
(10) Pub. No.: US 2005/0241105 A1
(43) Pub. Date: Nov. 3, 2005

(54) Slide hinge for recreational vehicle door

(76) Inventor: Robert B. Wiley, Marion, IN (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/115,036

(22) Filed: Apr. 26, 2005

Related U.S. Application Data
(60) Provisional application No. 60/565,312, filed on Apr. 26, 2004.

(51) Int. Cl. E05D 7/10

(52) U.S. Cl. 16/266

(57) ABSTRACT

The present invention uses a unique slide hinge, preferably mounted to the side of the exterior door for a storage compartment in a recreational vehicle. The hinge is particularly applicable for use with a trunk door on vehicles over 5,500 pounds gross vehicle weight. Unlike the more common piano hinges, the slide hinge provided by the present invention can be staked, i.e. “mechanically retained,” in an open orientation. For example, the hinge can be held in an orientation that forms a 90° angle between the door and the body of the recreational vehicle. The hinge also presents a low profile relative to the mounting surface when the hinge is in the open orientation.

This application claims the benefit of U.S. Provisional Patent Application No. 60/565,312, filed Apr. 26, 2004.

### FIELD OF THE INVENTION

The present invention is related to a slide hinge, and more particularly, to a slide hinge for exterior luggage compartment doors for a recreational vehicle.

### BACKGROUND OF THE INVENTION

Recreational vehicles provide a convenient and comfortable mode of travel. Such vehicles typically have one or more storage compartments accessible from outside the vehicle. The exterior doors to these compartments must allow the compartment to be readily opened to provide access to the compartment, while also maintaining a tight seal when closed to prevent water from entering the compartment. Currently, many interior doors are mounted using a piano-type hinge, often on the top of the door, or perhaps on the side of the door.

### SUMMARY OF THE INVENTION

The present invention uses a unique slide hinge, preferably mounted to the side of the exterior door for a storage compartment in a recreational vehicle. The hinge is particularly applicable for use with a trunk door on vehicles over 5,500 pounds gross vehicle weight. Unlike the more common piano hinges, the slide hinge provided by the present invention can be staked, i.e. “mechanically retained,” in an open position. For example, the hinge can be held in a position that forms a 90° angle between the door and the body of the recreational vehicle. The hinge also presents a low profile relative to the mounting surface when the hinge is in the open position.

The hinge includes a first mount, a second mount, and a linkage connecting the first mount to the second mount. The linkage comprises a first link pivotally mounted to the first mount at a first position, a second link pivotally mounted to the first mount at a second position spaced from the first position, a third link pivotally mounted to the second mount at a third position, and a fourth link pivotally mounted to the second mount at a fourth position spaced from the third position. The first link is pivotally connected to the third link at a location spaced from the first mount and the second mount, and the second link is pivotally connected to the third and fourth links at respective locations spaced from each other and the first mount and the second mount. The resulting linkage allows the second mount to move between a first orientation where the first mount is approximately perpendicular to the second mount and a second orientation where the first mount is approximately parallel to the second mount.

In an exemplary embodiment the first mount is a base mount and the second mount is a movable mount. The movable mount further includes a hole through which a pin can be inserted to lock the hinge in the second orientation by blocking movement of at least one of the links of the linkage. A door typically is mounted to the movable mount for movement therewith and the base mount typically is mounted to an inside wall of a compartment to support the movable mount as the door moves between respective open and closed orientations.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF THE DRAWINGS

FIG. 1 is a perspective view of a recreational vehicle with an open external compartment illustrating an exemplary application of the present invention.

FIG. 2 is a side view of a hinge provided by the present invention in a first orientation.

FIG. 3 is a side view of the hinge in FIG. 2 in a second orientation.

FIG. 4 is a perspective view of a vehicle door including a hinge provided by the present invention.

### DETAILED DESCRIPTION

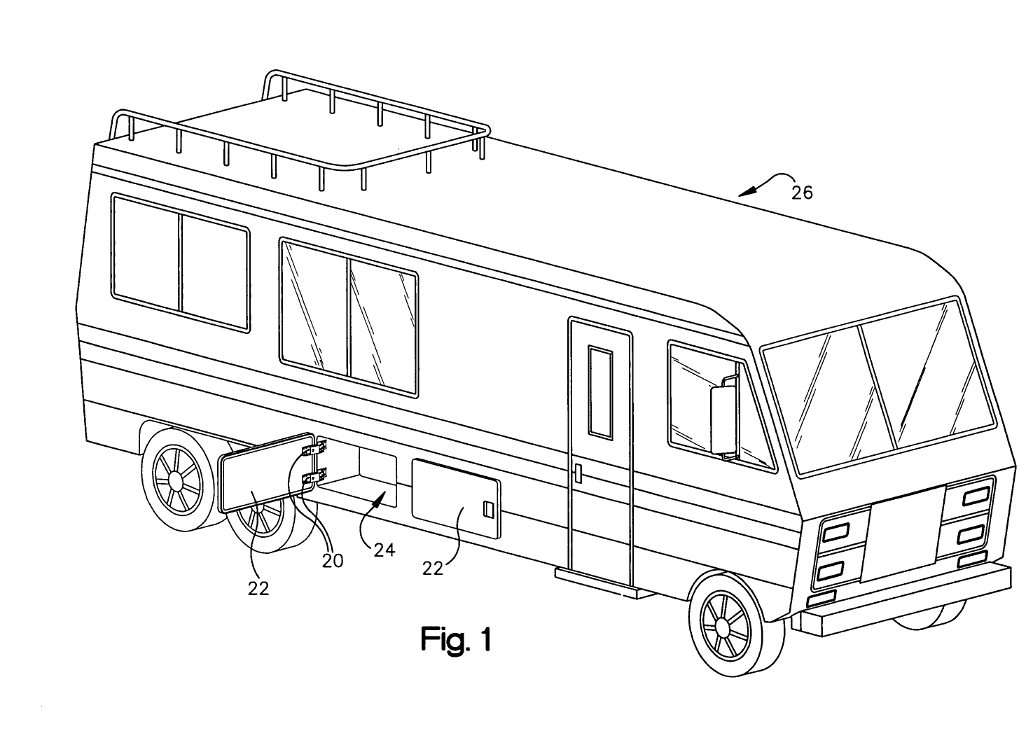

Referring now in detail to the drawings, and initially to FIG. 1, the present invention provides a slide hinge 20 that is particularly advantageous for use on an exterior door 22 of a storage compartment 24 of a recreational vehicle 26. In this case, multiple hinges, two hinges in the illustrated embodiment, are used to support the door.

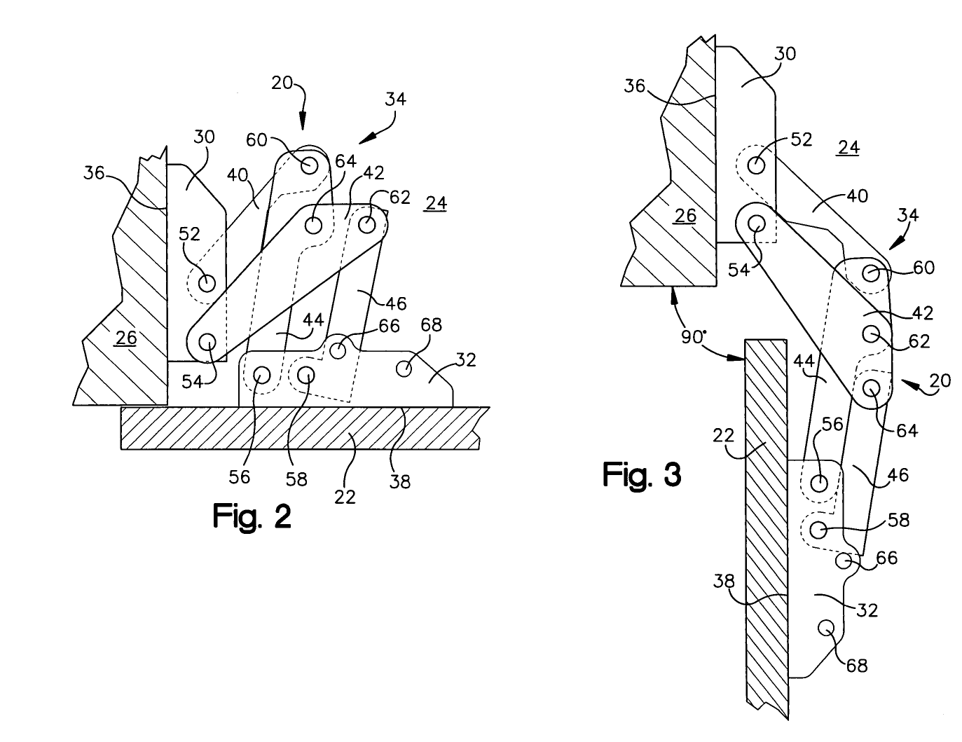

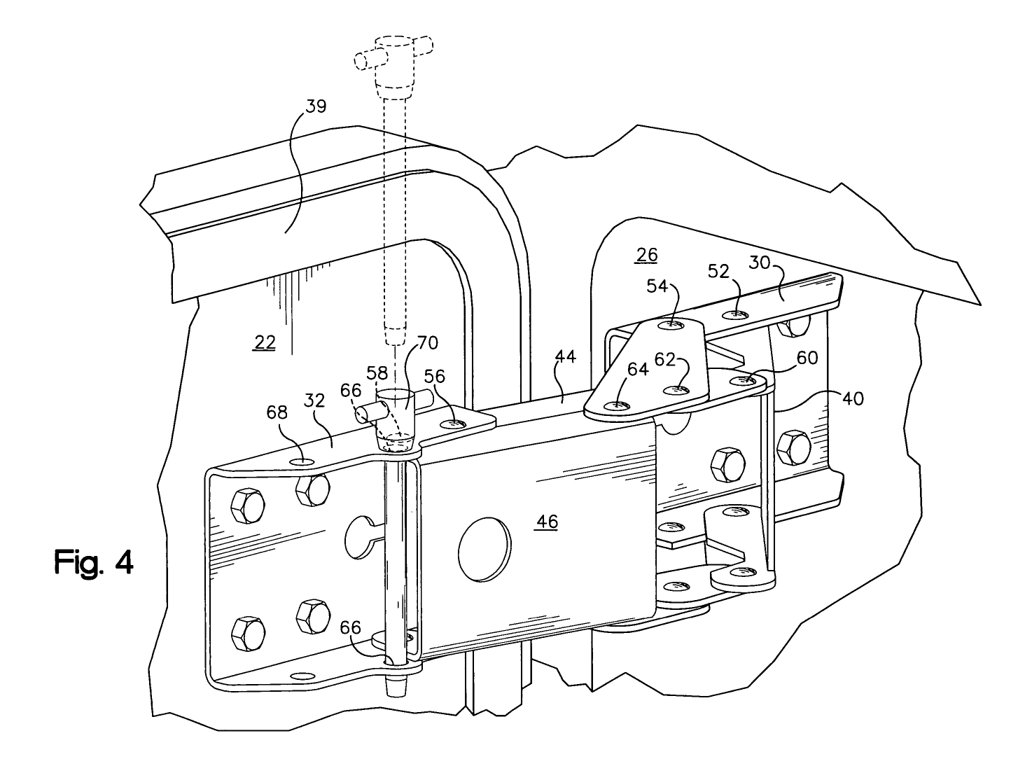

An exemplary hinge and its operation will be described with reference to FIGS. 2-10. The hinge 20 includes a first mount 30, a second mount 32, and a linkage 34 interconnecting the first mount 30 and the second mount 32. In the illustrated embodiment, the first mount 30 is a base mount that is mounted to a surface of the vehicle 26. The second mount 32 is a movable mount to which the exterior door 22 is mounted for movement therewith. The base mount 30 and the movable mount 32 are formed of a sheet metal and have an approximately U-shape cross-section, with the base of the U-shape defining a mounting face and the legs of the U-shape cross-section providing mounting surfaces for the linkage 34. The base mount 30 includes a generally planar mounting face 36 that typically is mounted to an inside wall of a storage compartment 24 (FIG. 1) and the movable mount 32 has a mounting face 38 that typically is mounted to an inside surface of a door 22 (FIG. 1). The door, particularly if it is an exterior door, typically will have one or more flexible, water-tight seals 39 mounted to the vehicle or the door or both.

When the hinge 20 is in a first orientation (FIG. 2, for example), the movable mount 32 holds the door 22 in a closed position 32 against the vehicle 26, with its mounting face 38 approximately perpendicular to the mounting face 36 of the base mount 30. When the hinge 20 is in a second orientation (FIG. 3, for example), the movable mount 32 is spaced from the vehicle 26 and oriented such that its mounting face 38 is substantially parallel to the mounting face 36 of the base mount 30. In the open position, the door 22 is at a ninety-degree angle with respect to an outer surface of the vehicle 26. The hinge 20 can hold the door in this position to make it easier to access the compartment, as will be described below.

Before describing a hold-open mechanism, however, we should describe the linkage 34 that enables the movable mount 32 to support and move a door 22 relative to the base mount 30. The linkage 34 connecting the base mount 30 and the movable mount 32 includes at least four links. In the illustrated embodiment the linkage 34 includes five links, although equivalent structures would be apparent to a person of ordinary skill in the art and more or fewer pieces could be used to construct the same linkage. The illustrated embodiments include first, second, third, and fourth links 40, 42, 44, 46, respectively. In the illustrated embodiment, the first, third and fourth links 40, 44 and 46 are formed of lengths of sheet metal having an approximately U-shape cross-section with the legs of the U-shape providing laterally spaced link members that act together. The second link 42 includes a pair of spaced apart link members that have identical shapes and are mounted on opposite lateral sides of the other links.

The first and second links 40 and 42 are mounted to the base mount 32 at one end thereof at spaced apart pivot points 52 and 54. The pivot points are formed of hollow rivet tubes that extend through openings in both the mounting surfaces of the base mount and the links 40 and 42 to connect the first and second links 40, 42 to respective sides of the base mount 30. Similarly, the third and fourth links 40, 46 are secured in the same manner to the movable mount 23 at spaced apart pivot points 56 and 58. The first link 40 is then pivotally or rotatably connected to the third link 44 at connection point 60 and the second link 42 also is connected to the third link 44 at connection point 62. The second link 42 also is pivotally connected to the fourth link 46 at connection point 64. The resulting linkage 34 thus allows the movable mount 32 to move between the first orientation shown in FIG. 2 and the second orientation shown in FIG. 3.

As is well known, varying the length of the respective links and the spacing between the connection points and pivot points can vary the position of the movable mount at the first and second orientations and orientations therebetween. For purposes of this description, there is no difference in operation between pivot points on the mounts and connection points in the linkage, the names were simply used to distinguish between the connections to the base mount and the movable mount on the one hand and the connections between and among the links themselves on the other hand.

Although the illustrated links are made of sheet metal, other materials and shapes of materials could be used to create the linkage provided by the present invention, depending on the loads involved and the strength of materials that are used. In an application such as this, where the hinge 20 is used to support an external door on a recreational vehicle, strength is important as the hinge may be called upon to endure a significant amount of abuse. The U-shape cross-section of the links provides improved stability and stiffness to the hinge in directions that cross the parallel pivot axes of the pivot points and connection points.

As previously mentioned, the hinge 20 can also be staked, in other words mechanically retained, in one or more positions, such as, but not limited to, the illustrated second orientation. One way to accomplish this is shown in the illustrated exemplary embodiment. In this embodiment the movable mount 32 includes a hole 66 through opposing legs (i.e. mounting surfaces) of the U-shape cross-section of the movable mount. A pin 70 can be inserted through those openings to hold the hinge in its second orientation. As shown in FIG. 3, when the pin 70 is inserted in the hole 66, the pin 70 interferes with movement of the fourth link 46 and thus prevents the linkage 34 from moving from the second orientation. Another hole 68 can be provided in the movable mount 32 to store the pin 70 in a position that does not interfere with movement of the linkage when the pin is not in use. Other means for holding the hinge 20 in the second orientation also can be provided and the present invention is not limited to a manually inserted pin. However, the ability to hold a door open in a fixed orientation such as this greatly facilitates loading and unloading the storage compartment that is served by the hinge.

It will be appreciated that the base mount 30 can be the first mount 30, as described above, or alternatively can be the second mount 32. Similarly, the movable mount 32 can be the second mount 32, as described above, or alternatively can be the first mount 30. The designation of the first mount 30 as the base mount and the second mount 32 as the moveable mount is merely for illustrative purposes. Therefore, it will be understood that the first and second mounts 30 and 32 can be either base or moveable mounts as desired.

Although the invention has been shown and described with respect to a certain preferred embodiment equivalent alterations and modifications will occur to others skilled in the art upon reading and understanding this specification and the annexed drawings. In particular regard to the various functions performed by the above-described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure that performs the function in the illustrated exemplary embodiment or embodiments of the invention.

1. A hinge having a first mount, a second mount, and a linkage connecting the first mount to the second mount, the linkage comprising:
a first link pivotally mounted to the first mount at a first position,
a second link pivotally mounted to the first mount at a second position spaced from the first position,
a third link pivotally mounted to the second mount at a third position; and
a fourth link pivotally mounted to the second mount at a fourth position spaced from the third position,
whereby the first link is pivotally connected to the third link at a location spaced from the first mount and the second mount, and the second link is pivotally connected to the third and fourth links at respective locations spaced from each other and the first mount and the second mount, thereby allowing the second mount to move between a first orientation where the first mount is approximately perpendicular to the second mount and a second orientation where the first mount is approximately parallel to the second mount.

2. A hinge as set forth in claim 1, wherein the second position is closer to the second mount than the first position.

3. A hinge as set forth in claim 1, wherein the third position is closer to the first mount than the fourth position.

4. A hinge as set forth in claim 1, wherein the second mount has a generally U-shape cross-section formed by a mounting face and two spaced-apart legs extending perpendicularly from the mounting face.

5. A hinge as set forth in claim 4, wherein the second mount further includes a hole through the spaced-apart legs of the second mount through which a pin can be inserted to lock the hinge in the second position by blocking movement of at least one of the links of the linkage.

6. A hinge as set forth in claim 1, wherein at least one of the links has a generally U-shape cross-section.

7. A hinge as set forth in claim 1, wherein the second link is pivotally connected to the third and fourth links along a line generally perpendicular to the first mount when the hinge is in the first orientation, and generally parallel to the first mount when the hinge is in the second orientation.

8. A hinge as set forth in claim 1, wherein at least one of the first mount, second mount, and linkage is formed from sheet metal.

9. A hinge as set forth in claim 1, wherein the first mount is a base mount, and the second mount is a movable mount movable between the first orientation and the second orientation.

10. A recreational vehicle having at least one storage compartment with at least one hinge as set forth in claim 1.

11. A hinge comprising:
a U-shape base mount having a first mounting face and a pair of spaced-apart legs extending perpendicularly from the first mounting face;
a U-shape movable mount having a second mounting face and a pair of spaced-apart legs extending perpendicularly from the second mounting face; and
a linkage connecting the base mount to the moveable mount, the linkage including:
a first link pivotally mounted to at least one of the pair of spaced-apart legs of the base mount at a first location;
a second link pivotally mounted to at least one of the pair of spaced-apart legs of the base mount at second location spaced from the first location;
a third link pivotally mounted to at least one of the spaced-apart legs of the movable mount at a third location; and
a fourth link pivotally mounted to at least one of the spaced-apart legs of the movable mount at a fourth position spaced from the third location;
wherein the first link is pivotally connected to the third link at a location spaced from the movable mount and the base mount, and the second link is pivotally connected to the third and fourth links at respective locations spaced from the movable mount and the base mount, thereby allowing the movable mount to move between a first orientation where the base mount is approximately perpendicular to the movable mount and a second orientation where the base mount is approximately parallel to the movable mount; and
wherein the movable mount further includes a hole through the spaced-apart legs of the movable mount through which a pin can be inserted to lock the hinge in the second orientation by blocking movement of at least one of the links of the linkage.

12. A hinge as set forth in claim 11, wherein the second position is closer to the second mount than the first position.

13. A hinge as set forth in claim 11, wherein the third position is closer to the first mount than the fourth position.

14. A hinge as set forth in claim 11, wherein at least one of the links has a generally U-shape cross-section.

15. A hinge as set forth in claim 11, wherein the second link is pivotally connected to the third and fourth links along a line generally perpendicular to the base mount when the hinge is in the first orientation, and generally parallel to the base mount when the hinge is in the second orientation.

16. A hinge as set forth in claim 11, wherein at least one of the base mount, movable mount, and linkage is formed from sheet metal.
